(19) United States
(12) Patent Application Publication
(10) Pub. No.: US 2018/0250795 A1
(43) Pub. Date: Sep. 6, 2018

(54) HOLDING DEVICE

(71) Applicant: HONDA MOTOR CO., LTD., Tokyo (JP)

(72) Inventors: Masakazu Adachi, Tochigi (JP); Nobuhiro Namba, Tochigi (JP); Atsushi Ueyama, Tochigi (JP); Akihiro Ishitani, Tochigi (JP)

(21) Appl. No.: 15/907,778

(22) Filed: Feb. 28, 2018

(30) Foreign Application Priority Data
Mar. 3, 2017 (JP) 2017-040456

(51) Int. Cl. B25B 5/16; B25B 5/02; B23Q 3/00

(52) U.S. Cl. CPC B25B 5/163; B23Q 2703/10; B23Q 3/00; B25B 5/02

(57) ABSTRACT

An objective is to provide a holding device capable of holding a hexagonal part at a nearly fixed orientation. A holding device 1 holds a bolt B by a left claw member 32L and a right claw member 32R. A left recessed portion 34L and a right recessed portion 34R in a recessed manner toward the bolt B in plan view are respectively formed in inner side end portions 33L and 33R facing the bolt B, of the claw members 32L and 32R, a pair of protruding portions 36L and 37L and a pair of protruding portions 36R and 37R protruding toward the bolt B are respectively formed in the portions 34L and 34R, the distances ra and rb from a center O to the portions 36L and 37L are equal in each of the claw members 32L and 32R, and the protrusion interval Δ is from d/√3 to d.

This application is based on and claims the benefit of priority from Japanese Patent Application No. 2017-040456, filed on 3 Mar. 2017, the content of which is incorporated herein by reference.

### BACKGROUND OF THE INVENTION

### Field of the Invention

The present invention relates to a holding device. More specifically, the present invention relates to a holding device that holds parts such as bolts and nuts having hexagonal side surfaces in plan view.

### Related Art

A large number of bolts are used in manufacturing vehicles. Therefore, in a vehicle assembly line, a fastening robot that fastens bolts into a workpiece, a part feeder that aligns and dispenses the bolts, and a delivery robot that takes out the bolts taken out from the part feeder and delivers the bolts to the fastening robot are provided.

By the way, the part feeder aligns a plurality of bolts at a predetermined orientation and dispenses the bolts. For example, a part feeder described in JP 2010-105766 A includes a linear feeder that causes an axial portion of each bolt to be inserted between rails and allows a head of the bolt to bridge the rails, thereby to align and take out the plurality of bolts.

Further, a delivery robot holds the heads of the bolts taken out from the linear feeder of the part feeder and dispenses the bolts to a fastening robot. As means for holding the head of the bolt in the delivery robot, means for attracting and holding the head with an electromagnet or means for holding two facing surfaces of six side surfaces of the head are known for holding the head.

### SUMMARY OF THE INVENTION

However, in the case of holding the head of the bolt using an electromagnetic, the bolt cannot be attracted at a fixed orientation on a constant basis, and in addition, the orientation of the bolt is changed when the bolt is moved at a high speed. Therefore, the bolt cannot be fastened at a fixed orientation and delivered to the robot. Therefore, a positioning device that precisely positions the bolt may further be required after the bolt is moved in the delivery robot. Further, in the case of using an electromagnet, if the size of the bolt is changed, the electromagnet cannot support the change and may not be able to appropriately deliver the bolt, and thus versatility is low.

Further, the direction of the side surface of the head of the bolt taken out from the linear feeder often varies. Therefore, in the case of holding two surfaces of the head to hold the head of the bolt, a device that aligns the side surfaces of the bolts taken out from the linear feeder to a fixed direction is separately required.

An objective of the present invention is to provide a holding device capable of holding a hexagonal part, such as a bolt or a nut, in plan view at a nearly fixed orientation with a simple configuration.

(1) A holding device (for example, a holding device 1 described below) of the present invention holds a part (for example, a bolt B described below) having hexagonal side surfaces in plan view by bringing a pair of plate-like members (for example, a left claw member 32L and a right claw member 32R described below) close to each other along a holding direction (for example, a chuck direction CD described below), recessed portions (for example, a left recessed portion 34L and a right recessed portion 34R described below) in a recessed manner toward the part in plan view are respectively formed in end portions (for example, inner side end portions 33L and 33R) facing the part, of the plate-like members, a pair of protruding portions (for example, a proximal end-side protruding portion 36L and a distal end-side protruding portion 37L, and a proximal end-side protruding portion 36R and a distal end-side protruding portion 37R) protruding toward the part are formed in both end portions of the recessed portion, distances (for example, distances ra and rb described below) from a holding center (for example, a holding center point O described below) of the part to the protruding portions are equal in each of the plate-like members, and an interval (for example, a protrusion interval Δ described below) along a direction (for example, a longitudinal direction LD described below) perpendicular to the holding direction, of the pair of the protruding portions formed in each of the plate-like members, is from d/√3 to d, both exclusive, where a width across flats of the side surfaces is d.

(2) In this case, the holding device favorably includes a chuck mechanism (for example, a parallel chuck 2 described below) that brings close to each other or separates the pair of plate-like members by moving the pair of plate-like members parallel along the holding direction.

(1) The holding device of the present invention holds a part having hexagonal side surfaces in plan view by bringing a pair of plate-like members close to each other along a holding direction, each of the plate-like members having a recessed portion and a pair of protruding portions. Here, the recessed portions are formed in inner end portions facing the part, of the plate-like members, and each of the recessed portions is formed in a recessed manner toward the part in plan view. Further, the pair of protruding portions is formed in a distal end-side end portion and a proximal end-side end portion of the recessed portion, and protrude toward the part. In a case where the center of the part held by the plate-like members is defined as a holding center, distances from the holding center to the protruding portions are equal. Further, in a case where the width across flats of side surfaces of the part is d, an interval along a direction perpendicular to the holding direction, of the pair of the protruding portions, is from d/√3 to d, both exclusive.

According to such a holding device, when the pair of plate-like members is brought close to each other along the holding direction, the part is held at a fixed orientation by the plate-like members by the following procedure. When the plate-like members are brought close to each other along the holding direction from a state where inner end portions of the plate-like members and the side surfaces of the part are separated, two of the four protruding portions formed in both the plate-like members come into contact with the side surfaces of the part. Here, although a combination of the two protruding portions coming into contact with the part, of the four protruding portions, changes depending on the directions of the side surfaces of the part before contact, in a case where the distal end-side protruding portion of one plate-like member comes into contact, the proximal end-side protruding portion of the other plate-like member comes into contact. Further, in a case where the proximal end-side protruding portion of one plate-like member comes into contact, the distal end-side protruding portion of the other plate-like member comes into contact. Therefore, when the plate-like members are brought close to each other in the state where two of the four protruding portions are in contact, an angular moment is caused in the part around its center as a rotation axis, and the part is rotated such that the side surfaces approach two non-contact protruding portions. When the plate-like members are brought closer to each other, the side surfaces of the part come into contact with the non-contact two protruding portions. As a result, the part is supported by the four protruding portions. Here, since the distances from the holding center to the protruding portions are equal, as described above, the orientation of the part in the state where the four protruding portions are in contact with the part is limited to an orientation where two side surfaces of the part are perpendicular to a sliding direction or an orientation where the two side surfaces are parallel to the sliding direction. With the configuration, according to the holding device of the present invention, the part can be held at either one of the two orientations without using a special device, by simply bringing the pair of plate-like members close to each other. Further, according to the holding device of the present invention, in a case where the interval of the pair of the protruding portions is Δ, the part can be held by the above procedure as long as the width across flats is from Δ to Δ×√3, both exclusive, and thus the holding device has high versatility.

(2) The holding device of the present invention includes the chuck mechanism that brings close to each other or separates the pair of plate-like members by moving the pair of plate-like members parallel along the holding direction. According to the holding device of the present invention, the part can be promptly held or released using such a chuck mechanism.

### BRIEF DESCRIPTION OF THE DRAWINGS

FIG. 1 is a front view of a holding device according to an embodiment of the present invention.

FIG. 2 is a side view of the holding device.

FIG. 3 is a sectional view of a pair of holding members along a line A-A in FIG. 1.

FIG. 4 is a plan view of both claw members and a bolt.

FIG. 5A is a view for describing a procedure of holding a bolt with the holding device.

FIG. 5B is a view for describing a procedure of holding a bolt with the holding device.

FIG. 5C is a view for describing a procedure of holding a bolt with the holding device.

### DETAILED DESCRIPTION OF THE INVENTION

Hereinafter, an embodiment of the present invention will be described in detail with reference to the drawings.

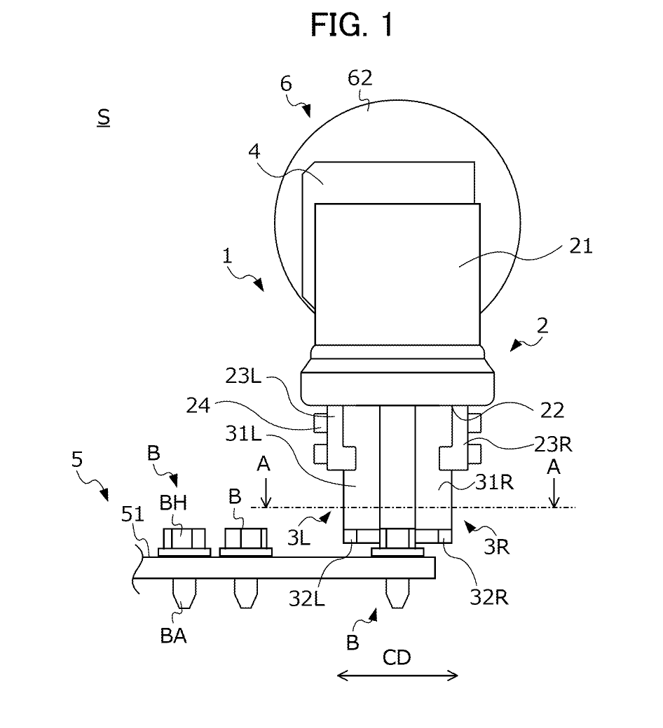

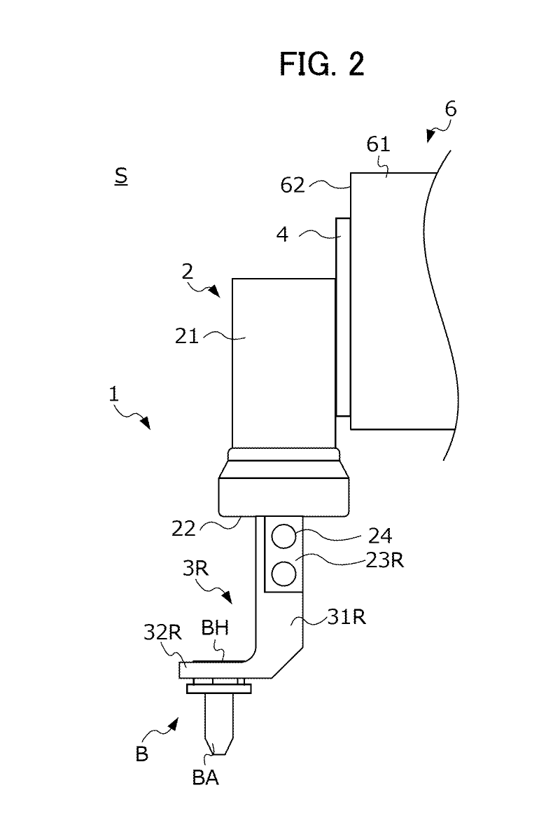

FIG. 1 is a diagram illustrating a configuration of a bolt supply system S to which a holding device 1 according to the present embodiment is applied. FIG. 2 is a side view of the holding device 1.

The bolt supply system S includes a part feeder 5 that aligns and takes out a bolt B that is a part having hexagonal side surfaces in plan view, a holding device 1 that holds the bolt B taken out from the part feeder 5, a robot 6 that moves the holding device 1, and a control device (not illustrated) that controls the aforementioned elements.

The part feeder 5 aligns a plurality of the bolts B put in a container (not illustrated) along a linear rail 51 and dispenses the bolts B. The bolts B are dispensed from the left side to the right side in FIG. 1 in a state where an axis BA of the bolt B is inserted in the rail 51 and a head BH of the bolt B bridges the rail 51.

The holding device 1 is attached to a distal end portion 62 of an arm 61 of the robot 6. The robot 6 conveys the holding device 1 to a predetermined conveyance position together with the bolts B held by the holding device 1.

The holding device 1 includes a pair of a left holding member 3L and a right holding member 3R, a parallel chuck 2 that supports the pair of holding members 3L and 3R, and a mounting bracket 4 that connects the parallel chuck 2 and the distal end portion 62.

The parallel chuck 2 includes a columnar chuck main body 21 extending along an up and down direction in FIG. 1, a left hand 23L and a right hand 23R having a rod shape and extending downward parallel to each other from a bottom portion 22 of the chuck main body 21, and an actuator (not illustrated) provided in the chuck main body 21 and which brings close to each other or separates the pair of hands 23L and 23R by moving the pair of hands 23L and 23R parallel along a guide extending along a chuck direction CD.

As illustrated in FIG. 2, the right holding member 3R has an approximately L-shape in side view, and includes a right base portion 31R extending along the up and down direction in FIG. 2 and a right claw member 32R extending from a lower end portion of the right base portion 31R toward the left in FIG. 2. Further, similarly, the left holding member 3L has an approximately L-shape in side view, and includes a left base portion 31L extending along the up and down direction and a left claw member 32L vertically extending from the lower end portion of the left base portion 31L. The holding members 3L and 3R are fixed to the hands 23L and 23R at the base portions 31L and 31R, respectively, by a plurality of fastening members 24.

The holding device 1 holds the bolt B having the hexagonal head BH in plan view by bringing the pair of claw members 32L and 32R close to each other along the chuck direction CD with the parallel chuck 2. Hereinafter, specific configurations of the claw members 32L and 32R will be described in detail.

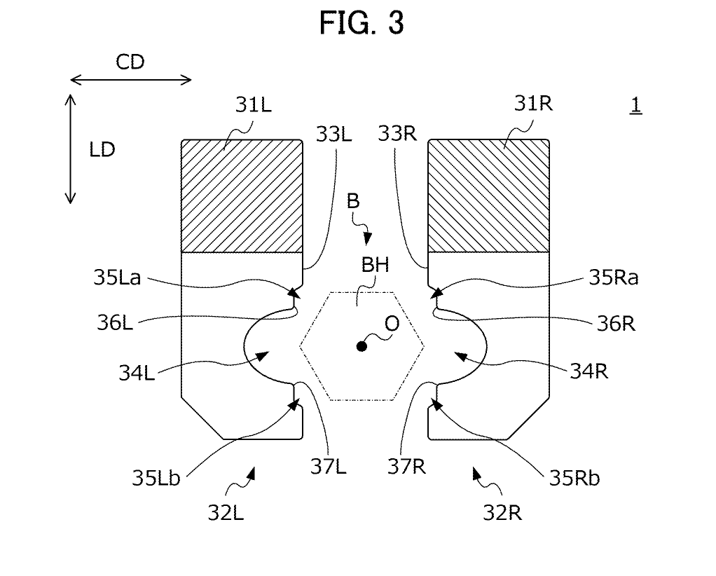

FIG. 3 is a sectional view of the pair of holding members along the line A-A in FIG. 1. Note that, in FIG. 3, the head BH of the bolt B held by the holding members as the holding members are brought closest to each other along the chuck direction CD is illustrated by the one dot chain line. Further, a holding center point that is the center of the bolt B held by the holding members is illustrated with the sign “O” in FIG. 3.

As illustrated in FIG. 3, each of the claw members 32L and 32R has a plate shape in plan view extending from each of the base portions 31L and 31R toward a distal end side along a longitudinal direction LD perpendicular to the chuck direction CD. A left recessed portion 34L and a right recessed portion 34R formed in a recessed manner toward the bolt B in plan view are respectively formed in inner side end portions 33L and 33R facing the bolt B, of the claw members 32L and 32R.

Notched portions 35La and 35Lb formed in a recessed manner toward the bolt B in plan view are formed in a proximal end-side corner portion and a distal end-side corner portion of the left recessed portion 34L, of the inner side end portion 33L of the left claw member 32L. These notched portions 35La and 35Lb are formed by being notched shallower than the left recessed portion 34L. With the structure, a proximal end-side protruding portion 36L and a distal end-side protruding portion 37L protruding toward the holding center point O are respectively formed between the notched portion 35La and the left recessed portion 34L and between the notched portion 35Lb and the left recessed portion 34L. Further, distal end portions of the protruding portions 36L and 37L are chamfered.

Further, notched portions 35Ra and 35Rb formed in a recessed manner toward the bolt B in plan view are formed in a proximal end-side corner portion and a distal end-side corner portion of the right recessed portion 34R, of the inner side end portion 33R of the right claw member 32R. These notched portions 35Ra and 35Rb are formed by being notched shallower than the right recessed portion 34R. With the structure, a proximal end-side protruding portion 36R and a distal end-side protruding portion 37R protruding toward the holding center point O are respectively formed between the notched portion 35Ra and the right recessed portion 34R and between the notched portion 35Rb and the right recessed portion 34R. Further, distal end portions of the protruding portions 36R and 37R are chamfered.

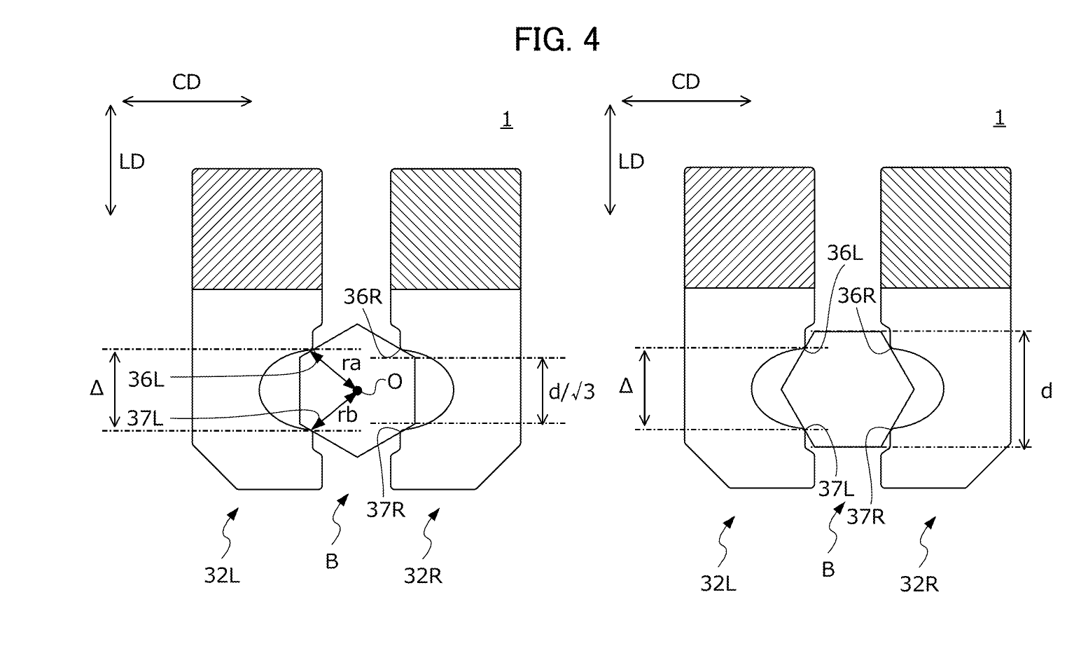

FIG. 4 is a plan view of both the claw members 32L and 32R and the bolt B. As will be described below, in the holding device 1, the bolt B can be held at either of two types of orientation: a perpendicular orientation where two surfaces of the bolt B are perpendicular to the chuck direction CD; and a parallel orientationin which two surfaces of the bolt B are parallel to the chuck direction CD, by the above-described four protruding portions 36L, 36R, 37L, and 37R. The left side in FIG. 4 illustrates the case in which the bolt B is held in the perpendicular orientation, and the right side in FIG. 4 indicates the case in which the bolt B is held in the parallel orientation. Further, FIG. 4 illustrates the width across flats of the bolt B with “d”, and an interval along the longitudinal direction LD from the distal end portion of the proximal end-side protruding portion 36L to the distal end portion of the distal end-side protruding portion 37L formed in the left claw member 32L (hereinafter, the interval is referred to as “protrusion interval”) with “Δ”. Note that the protrusion interval of the right claw member 32R is equal to the protrusion interval Δ of the left claw member 32L and thus illustration is omitted.

As illustrated on the left side in FIG. 4, a distance ra from the holding center point O to the proximal end-side protruding portion 36L and a distance rb from the holding center point O to the distal end-side protruding portion 37L are equal. Further, as for the right claw member, similarly, a distance from the holding center point O to the proximal end-side protruding portion 36R and a distance from the holding center point O to the distal end-side protruding portion 37R are equal although illustration is omitted.

As illustrated on the right side in FIG. 4, to cause the four protruding portions 36L, 36R, 37L, and 37R of the claw members 32L and 32R to come into contact with the head of the bolt B to hold the bolt B in the parallel orientation, the protrusion interval Δ needs to be smaller than the width across flats d. Further, as illustrated on the left side in FIG. 4, to cause the four protruding portions 36L, 36R, 37L, and 37R of the claw members 32L and 32R to come into contact with the head of the bolt B to hold the bolt B in the perpendicular orientation, the protrusion interval Δ needs to be larger than an interval of one surface (d/√3) of the head 2B of the bolt B. Therefore, the protrusion interval Δ of each of the claw members 32L and 32R is set to fall within a range from d/√3 to d, both exclusive, to satisfy both conditions to hold the bolt in either the perpendicular orientation or the parallel orientation.

$$\frac{d}{\sqrt{3}} < Δ < d \qquad ( 1 )$$

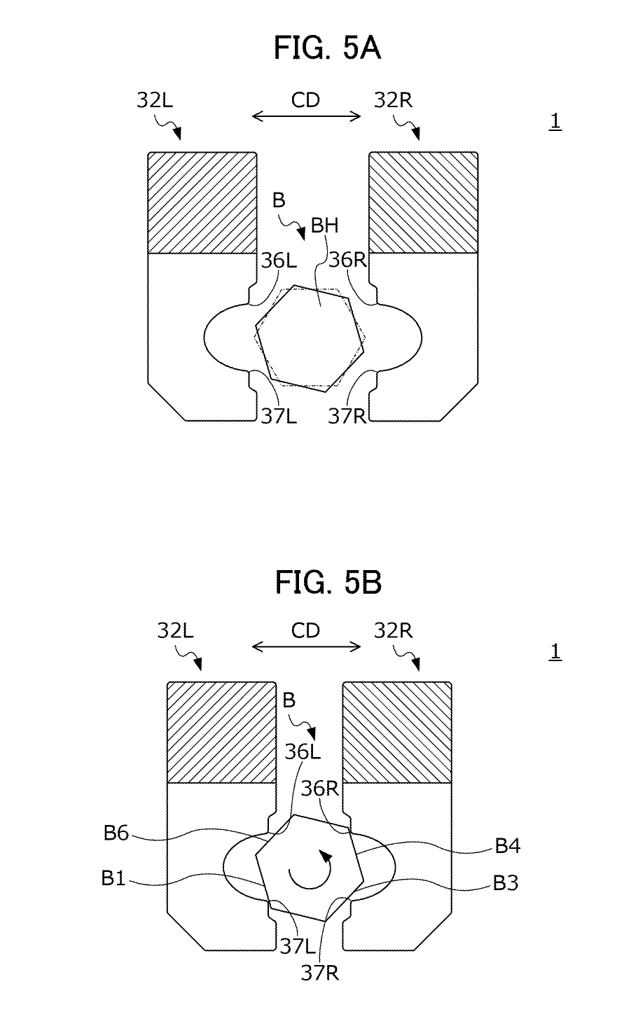

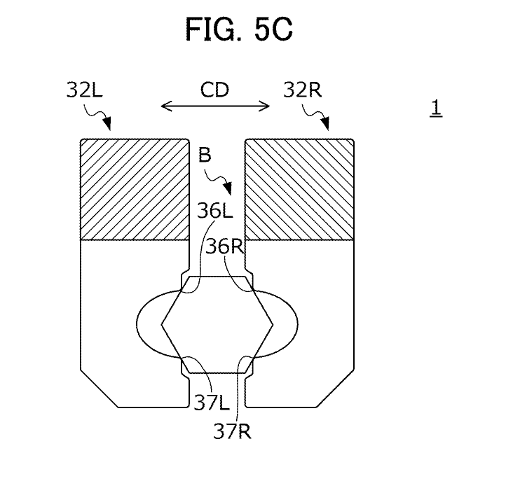

Next, a procedure of holding the bolt B by the holding device 1 will be described with reference to FIGS. 5A to 5C. As illustrated in FIG. 5A, assume that the bolt B is provided between both the claw members 32L and 32R in a state of being slightly inclined in a clockwise manner with respect to the final holding orientation (parallel orientation) illustrated by the one dot chain line.

As illustrated in FIG. 5B, when both the claw members 32L and 32R are moved parallel along the chuck direction CD and brought close to each other from the state illustrated in FIG. 5A, the two protruding portions 37L and 36R, of the four protruding portion 36L, 36R, 37L, and 37R, come into contact with two facing side surfaces B1 and B4 of the six side surfaces of the bolt B. Therefore, when both the claw members 32L and 32R are brought closer to each other in the state where the two protruding portions 37L and 36R are in contact, a counterclockwise angular moment in FIG. 5B is caused in the bolt B around its center as a rotation axis, and the bolt B is rotated such that a side surface B6 approaches the non-contact protruding portion 36L and a side surface B3 approaches the non-contact protruding portion 37R. When both the claw members 32L and 32R are brought closer to each other, the side surface B6 of the bolt B comes into contact with the protruding portion 36L, and the side surface B3 comes into contact with the protruding portion 37R, whereby the bolt B is supported in the parallel orientation by the four protruding portions 36L, 36R, 37L, and 37R, as illustrated in FIG. 5C.

Although an illustration and detailed description are omitted, in a case where the orientation of the bolt B before being held is closer to the perpendicular orientation, when both the claw members 32L and 32R are moved parallel along the chuck direction CD and brought close to each other, the angular moment is caused in the bolt B around its center as a rotation axis, similarly to the example of FIGS. 5A to 5C, and the bolt B is supported in the perpendicular orientation by the four protruding portions 36L, 36R, 37L, and 37R.

As described above, according to the holding device 1 of the present embodiment, by simply bringing the pair of claw members 32L and 32R close to each other, the bolt B can be held in either the perpendicular orientationor the parallel orientation without using a special device. Further, as illustrated in the above formula (1), the holding device 1 of the present invention can hold the bolt B by setting the protrusion interval Δ to fall within the range from d/√3 to d, both exclusive, where the width across flats of the bolt B is d. In other words, the holding device 1 having the protrusion interval Δ can hold the bolt with the width across flats of from Δ to Δ×√3, both exclusive. That is, the holding device 1 can be applied to a bolt having any width across flats d as long as the width across flats d falls within the range determined according to the magnitude of the protrusion interval Δ, and thus has versatility.

An embodiment of the present invention has been described. However, the present invention is not limited to the embodiment. For example, in the above-described embodiment, the case of holding the head of the bolt by the holding device has been described. However, the present invention is not limited to this case. The holding device of the present invention can be applied not only to the bolt but also to a nut. Further, the holding device of the present invention can be applied not only to the bolt and nut but also to any parts as long as the parts have hexagonal side surfaces in plan view.

What is claimed is:

1. A holding device for holding a part having hexagonal side surfaces in plan view by bringing a pair of plate-like members close to each other along a holding direction, wherein
recessed portions in a recessed manner toward the part in plan view are respectively formed in end portions facing the part, of the plate-like members;
a pair of protruding portions protruding toward the part are formed in both end portions of the recessed portion;
distances from a holding center of the part to the protruding portions are equal in each of the plate-like members, and
an interval along a direction perpendicular to the holding direction, of the pair of the protruding portions formed in each of the plate-like members, is from d/√3 to d, both exclusive, where a width across flats of the side surfaces is d.

2. The holding device according to claim 1, comprising:
a chuck mechanism that brings the pair of plate-like members close or separates the pair of plate-like members by moving the pair of plate-like members parallel along the holding direction.
